(19) United States
(12) Patent Application Publication
(10) Pub. No.: US 2020/0090503 A1
(43) Pub. Date: Mar. 19, 2020

(54) METHOD, APPARATUS, AND SYSTEM FOR REAL-TIME DETECTION OF ROAD CLOSURES

(71) Applicant: HERE GLOBAL B.V., Eindhoven (NL)

(72) Inventors: Daniel ROLF, Berlin (DE); Mirko MAISCHBERGER, Berlin (DE)

(21) Appl. No.: 16/130,676

(22) Filed: Sep. 13, 2018

(51) Int. Cl. G08G 1/01; G08G 1/052; G06F 17/30

(52) U.S. Cl. CPC G08G 1/0133; G08G 1/0116; G06F 17/30241; G08G 1/052; G08G 1/0141

(57) ABSTRACT

An approach is provided for detecting traffic anomalies in real-time using sparse probe-data. The approach involves processing probe data collected from a partition of a digital map to determine a probe origin point, a probe destination point, or a combination thereof. The approach also involves generating an origin/destination matrix for the partition based on the origin point, destination point, or combination thereof. The approach further involves calculating an estimated traffic flow for road segments of the partition based on the matrix. The approach also involves determining a road segment from among the plurality for which the estimated traffic flow differs by more than a threshold value from an observed traffic flow indicated by the probe data for the least one road segment. The approach further involves providing data to indicate a detection of the traffic anomaly on the at least one road segment based on the difference.

### BACKGROUND

Providing data on traffic anomalies or incidents (e.g., abnormalities in traffic that can affect traffic flow such as accidents, lane closures, road closures, etc.) is an important function for map service providers. While most traffic anomalies can have at least some negative impact on traffic, road closures can be the most severe because no vehicles can travel through the affected roadway. The lack of knowledge, particularly real-time knowledge, about a road closure can have an enormous negative impact on a user's trip planning, routing, and/or estimated time of arrival. In the absence of probe or third-party data (e.g., crowd-sourced information) related to a specific road segment, current systems are blind in detecting road closures in real-time.

### SOME EXAMPLE EMBODIMENTS

Therefore, there is a need for detecting traffic anomalies in real-time using sparse probe-data.

According to one embodiment, a computer-implemented method for detecting a traffic anomaly comprises processing probe data collected from a partition of a digital map to determine at least one probe origin point, at least one probe destination point, or combination thereof. The method also comprises generating an origin/destination matrix for the partition based on the at least one probe origin point, at least one probe destination point, or the combination thereof. The method further comprises calculating an estimated traffic flow for a plurality of road segments of the partition based on the origin/destination matrix. The method also comprises determining at least one road segment from among the plurality of road segments for which the estimated traffic flow differs by more than a difference threshold value from an observed traffic flow indicated by the probe data for the least one road segment. The method further comprises providing data to indicate a detection of the traffic anomaly on the at least one road segment based on the difference.

According to another embodiment, an apparatus for detecting a traffic anomaly comprises at least one processor, and at least one memory including computer program code for one or more computer programs, the at least one memory and the computer program code configured to, with the at least one processor, cause, at least in part, the apparatus to generate an origin/destination matrix for a partition of a digital map based on at least one probe origin point, at least one probe destination point, or a combination thereof determined from probe data collected from the partition. The apparatus is also caused to calculate an estimated traffic flow for a plurality of road segments of the partition based on the origin/destination matrix and map data associated with the plurality of road segments. The apparatus is further caused to compare the estimated traffic flow to an observed traffic flow indicated by the probe data to detect a traffic anomaly on at least one road segment.

According to another embodiment, a non-transitory computer-readable storage medium for detecting a traffic anomaly carrying one or more sequences of one or more instructions which, when executed by one or more processors, cause, at least in part, an apparatus to generating an origin/destination matrix for a partition of a digital map based on the at least one probe origin point, at least one probe destination point, or a combination thereof determined from probe data collected from the partition. The apparatus is also caused to calculate an estimated traffic flow for a plurality of road segments of the partition based on the origin/destination matrix and map data associated with the plurality of road segments. The apparatus is further caused to compare the estimated traffic flow to an observed traffic flow indicated by the probe data to detect a traffic anomaly on at least one road segment. The apparatus is further caused to provide data to update a geographic database based on the traffic anomaly.

According to another embodiment, an apparatus for detecting a traffic anomaly comprises means for processing probe data collected from a partition of a digital map to determine at least one probe origin point, at least one probe destination point, or a combination thereof. The apparatus also comprises means for generating an origin/destination matrix for the partition based on the at least one probe origin point, at least one probe destination point, or the combination thereof. The apparatus further comprises means for calculating an estimated traffic flow for a plurality of road segments of the partition based on the origin/destination matrix and map data associated with the plurality of road segments. The apparatus also comprises means for determining at least one road segment from among the plurality of road segments for which the estimated traffic flow differs from an observed traffic flow indicated by the probe data for the least one road segment according to a function of the estimated traffic flow and map data. The apparatus further comprises means for providing data to indicate a detection of the traffic anomaly on the at least one road segment based on the difference.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of detecting traffic anomalies in real-time using sparse probe-data, according to one embodiment;

FIG. 2 is an example of a partition of a road network identified by natural cuts, according to one embodiment;

FIG. 3A is a visual representation of an example of actual travel routes through the partition of FIG. 2, according to one embodiment;

FIG. 3B is an example of an origin/destination (O/D) matrix at the border of the partition of FIG. 2, according to one embodiment;

FIG. 4 is a visual representation of an example of estimated traffic flows through the partition of FIG. 2, according to one embodiment;

FIG. 5 is a diagram of the components of a traffic platform configured to detect traffic anomalies in real-time using sparse probe-data, according to one embodiment;

FIG. 6 is a flowchart of a process for detecting traffic anomalies in real-time using sparse probe data, according to one embodiment;

FIG. 7 is a flowchart of a process of describing a traffic anomaly or incident on a road segment based on a comparison of theoretical and actual traffic flows on the segment, according to one embodiment;

FIG. 8 is flowchart of a process for monitoring a temporal evolution of traffic on a road segment, according to one embodiment;

FIGS. 9A and 9B are diagrams of example user interfaces for detecting traffic anomalies in real-time using spare probe data, according to one embodiment;

FIG. 10 is a diagram of a geographic database, according to one embodiment;

FIG. 11 is a diagram of hardware that can be used to implement an embodiment;

FIG. 12 is a diagram of a chip set that can be used to implement an embodiment; and

FIG. 13 is a diagram of a mobile terminal (e.g., handset or vehicle or part thereof) that can be used to implement an embodiment.

### DESCRIPTION OF SOME EMBODIMENTS

Examples of a method, apparatus, and computer program for detecting traffic anomalies in real-time using sparse probe-data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

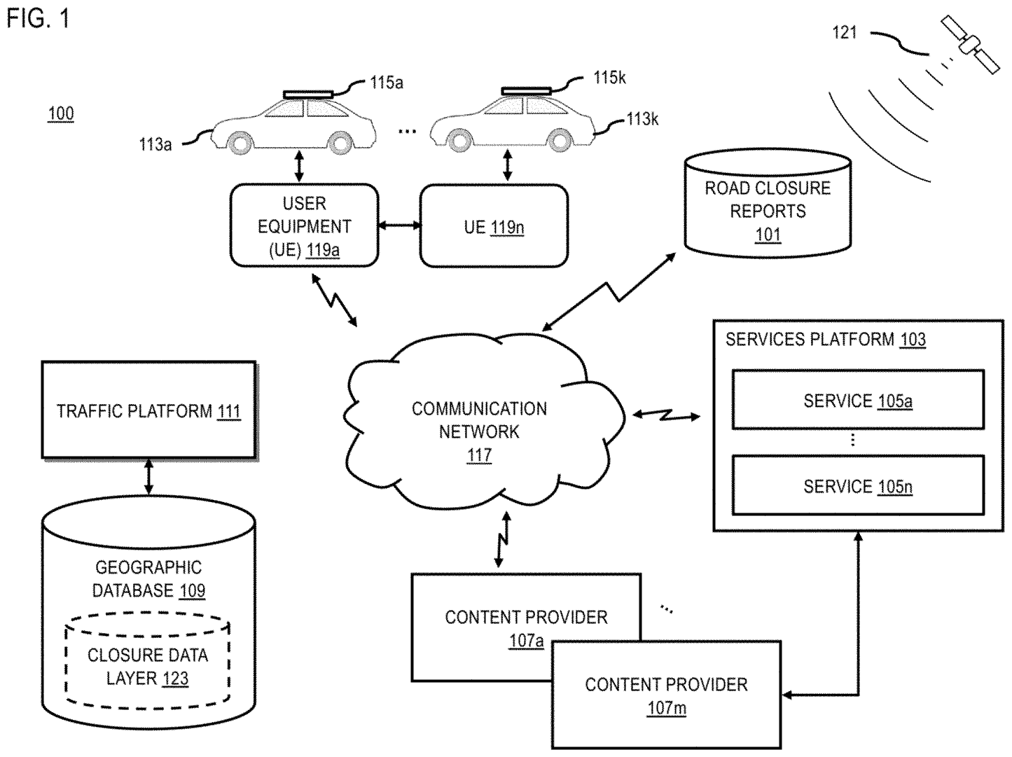

FIG. 1 is a diagram of a system 100 capable of detecting traffic anomalies in real-time using sparse probe-data, according to one embodiment. Generally, traffic anomalies or incidents such as road closures (e.g., road closure reports 101) are published by government/municipality agencies, local police, and/or third-party official/semi-official sources (e.g., a services platform 103, one or more services 105a-105n (also collectively referred to herein as services 105), one or more content providers 107a-107m (also collectively referred to herein as content providers 107), etc.). By way of example, the published road closure reports 101 can specify the roadway or link (e.g., by name or matched to specific road link records of digital map data such as a geographic database 109) that has been closed or partially closed to traffic (e.g., vehicular and/or non-vehicular traffic). Closure refers, for instance, to restricting traffic flow on a particular roadway such that no vehicles or a reduced number of vehicles (e.g., reduced with respect to an average free flow traffic volume on the roadway) are permitted or able to travel on the roadway. In one embodiment, a traffic provider (e.g., via a traffic platform 111) monitors the feeds of the road closures reports 101, extracts the affected roadways, and provides traffic data and/or other functions based on the road closure reports 101 (e.g., displays the location of reported closures on a map, generates navigation routes to avoid reported road closures, etc.). Then, traditional traffic service providers wait for another message or road closure report 101 indicating that the road has opened to provide updated data and/or functions. In other words, traditional traffic service providers have historically placed total reliance on these road closure reports 101.

However, in the absence of probe or crowd-sourced information related to a specific road segment, current systems are blind in detecting traffic anomalies (e.g., road closures) in real-time. As described above, the lack of knowledge, particularly real-time knowledge, about a road closure can have an enormous negative impact on a user's trip planning, routing, and/or estimated time of arrival. Moreover, when probe coverage of a specific area is low or absent, despite sufficient probe coverage in the general region being sufficient, there is currently no reliable method to know if the low probe data is explained by no users actually having an interest in traversing the area or their inability to do so due to an exceptional unforeseen event such as a road closure. Knowing the actual reason has great value for other users that may also want to traverse the area.

To address this problem, the system 100 introduces a capability to infer the inability to traverse a road segment (e.g., because of heavy congestion or a road closure) based on information on the borders (and existing internal sources and sinks) of an area containing the road segment and map data. In one embodiment, given a partition of a road network under study (e.g., identified with a natural cut), the system 100 can use crowd-sourced probe data (e.g., coming from users of insurance trackers, mobile device applications, or navigation systems) to estimate the O/D matrix at the border of the area and/or existing internal sources and sinks.

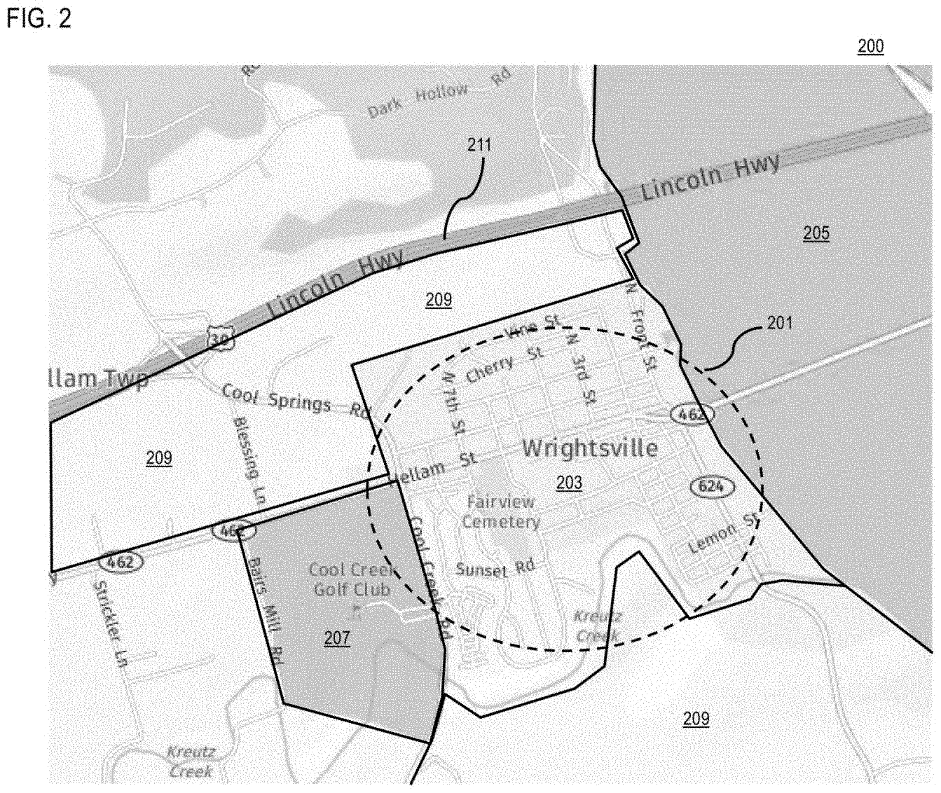

FIG. 2 is an example of a partition of a road network identified by natural cuts, according to one embodiment. In one embodiment, the system 100 uses a cloud-computing system to partition a map of a road network. In one instance, the system 100 partitions the map 200 using the natural cuts identified by the Partitioning Using Natural Cut Heuristics (PUNCH) algorithm. By way of example, natural cuts are sparse cuts (e.g., mountains, parks, rivers, deserts, sparse areas, freeways, political borders, etc.) separating a local region from the rest of the graph. In this example, the system 100 creates the partition 201 based on the town or city 203 (e.g., Wrightsville) and the natural cuts such as the river 205, the park 207, the sparse areas 209, and the freeway 211.

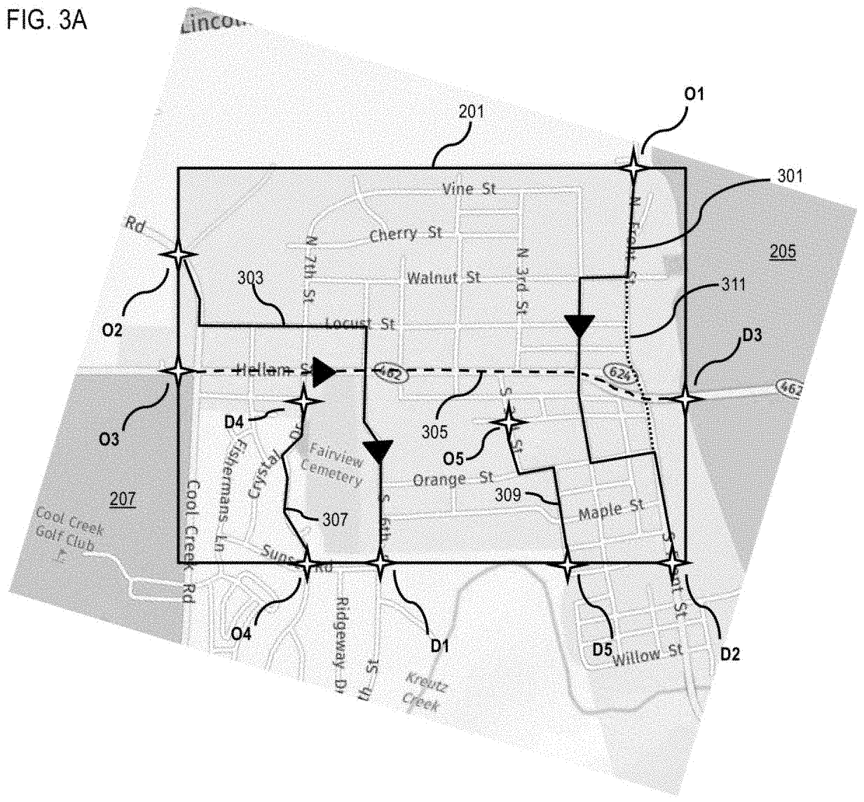

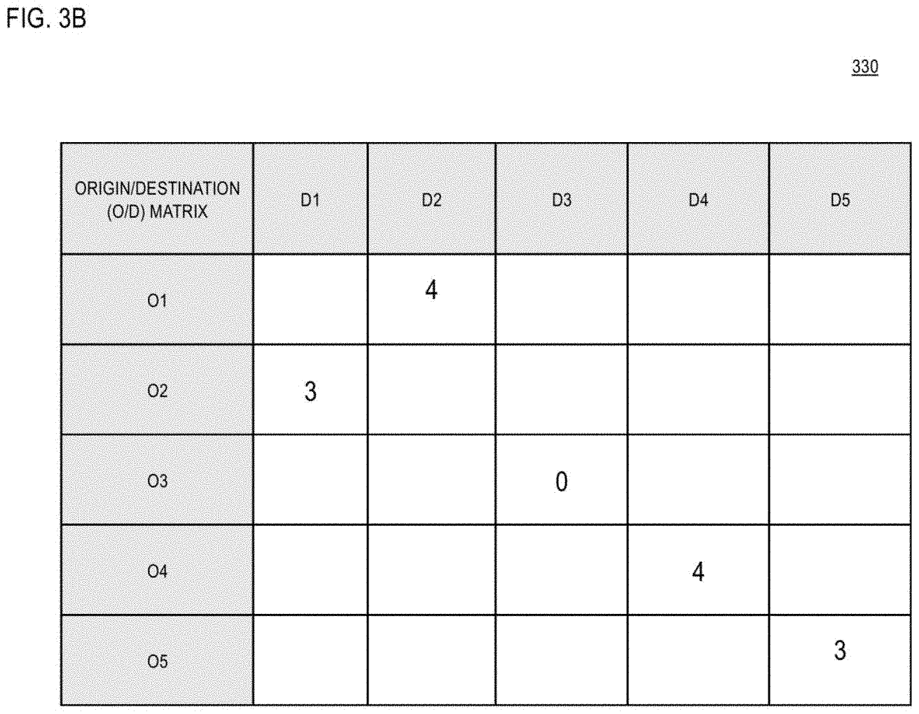

FIG. 3A is a visual representation of an example of actual travel routes through the partition of FIG. 2, and FIG. 3B is an example of an O/D matrix of the partition of FIG. 2, according to one embodiment. In one embodiment, for each partition, especially inside a city (e.g., city 203), the system 100 generates an O/D matrix identified by the sensor data entering (origin (O)) and exiting (destination (D)) the area or partition 201 in the last At second. In this instance, the origin and destination points or vertices O1-D2, O2-D1, O3-D3, O4-D4, and O5-D5 are connected by roads 301, 303, 305, 307, and 309 respectively. It should be noted that whereas the origin points and destination points of roads 301, 303, and 305 are at the border of the area or partition 201, the origin point of road 307 (O4) is at the border, but the destination point (D4) is an existing internal sink within the area. Similarly, the destination point of road 309 (D5) is at the border, but the origin point (O5) is an existing internal source within the area. In this example, the probe coverage along each travel route is low or absent. In one embodiment, the system 100 maps calculated vehicle paths onto the roadway graph or closure link graph (e.g., O/D matrix 330) such that O1-D2=4, O2-D1=3, O3-D3=0, O4-D4=4, and O5-D5=3, as shown in FIG. 3B.

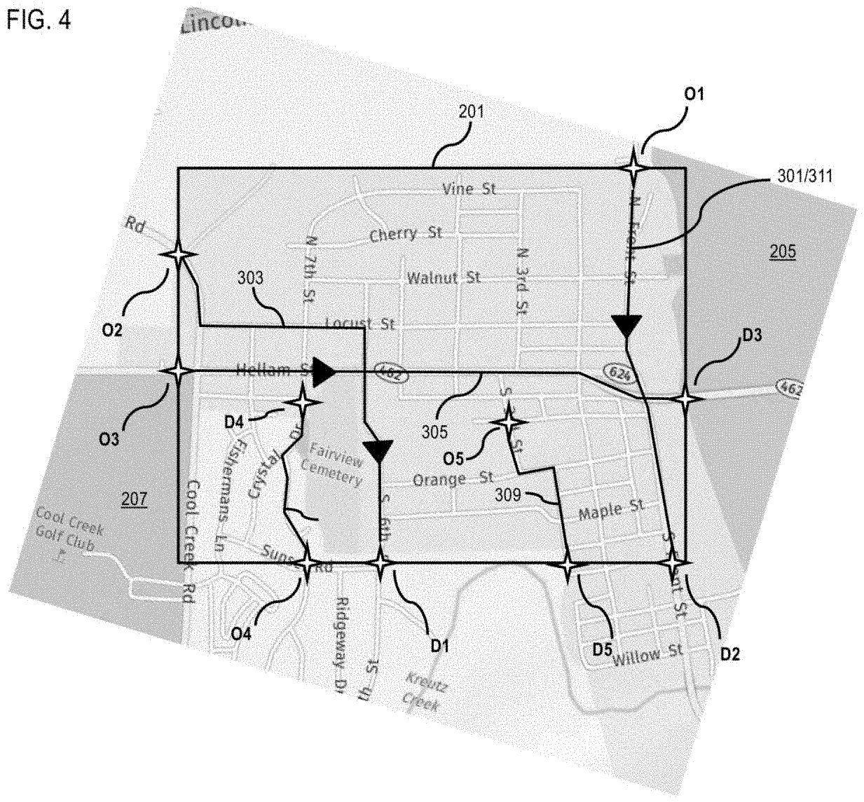

FIG. 4 is a visual representation of an example of estimated traffic flows through the partition of FIG. 2, according to one embodiment. In one embodiment, once the system 100 determines the O/D matrix of the area 201 (e.g., FIG. 3B), the system 100 solves the Traffic Assignment (TA) or Route Assignment problem inside the area (e.g., area 201). In one embodiment, the system 100 uses a TA algorithm to find the Nash or user equilibrium of the network using the map 200 provided capacity and free flow speed for each road segment (i.e., the system 100 determines a flow assignment on the road segments which satisfies the demand for each O/D pair and minimizes each user's travel time). In one instance, the system 100 improves the O/D matrix iteratively until the error between the reported speed and the estimated speed reported by the probes is sufficiently low. The system 100 can then apply a simple rule to identify the road segments (e.g., roads 301 and 305) for which the capacity reported by the map data does not correspond to the flow assigned by the solution to the Traffic Assignment algorithm. For example, the system 100 can assign a probability of being blocked to the road segments that would provide a better route to a certain percentage of the users, but do not experience any probe data (e.g., road 311).

In one embodiment, the system 100 compares the theoretical flow on each road with the actual flow reported by the sensors (e.g., O/D matrix 330) to adjust the capacity of the segments in real time. As previously described, in one embodiment, the actual flow is determined by the system 100 from the sensor data entering and exiting the area 201 and/or starting/ending in the area 201 and not based on probe or third-party data (e.g., crowd-sourced data) traveling within the area 201. In one instance, where the system 100 determines that the flow computed by the TA algorithm is much greater than the actual flow identified by the probes (e.g., O1-D2), the system 100 can identify the flow (e.g., road 301) as a heavy congestion (with only a few probes that would not guarantee coverage). In one embodiment, when the system 100 determines that the flow reported by the probes is close to null, and therefore the theoretical flow is significant (e.g., O3-D3), the system 100 can determine that the segment (e.g., road 305) is closed even in absence of any probe report on the segment (e.g., a road closure report 101). The system 100 then reports, in one instance, the closures and heavy traffic conditions for the links or routes with low probe coverage (and as such low confidence with traditional methods) to a user. Consequently, a user can alter or modify her or his trip planning, routing, and/or estimated time of arrival accordingly.

In summary, according to various embodiments, the system 100 can infer the inability to traverse a road segment (e.g., road 305), based on information on the borders of an area (e.g., area 201) (and existing internal sources and sinks) containing the road segment and map data.

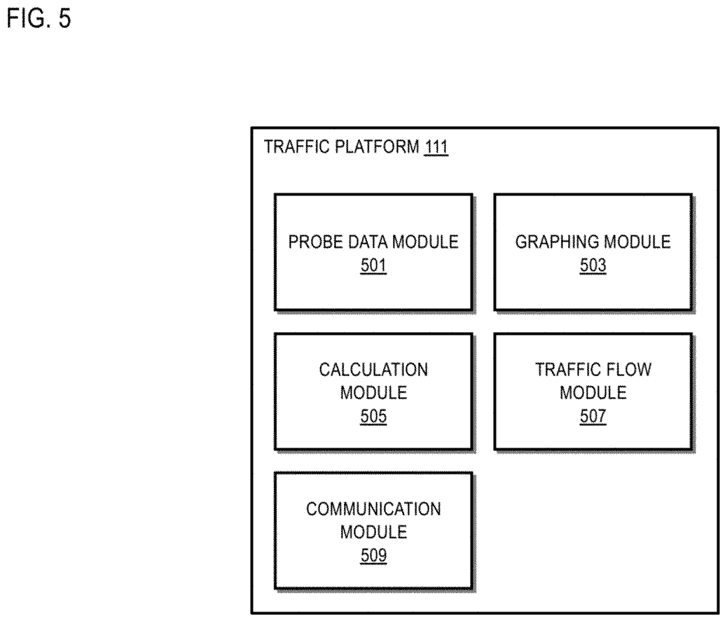

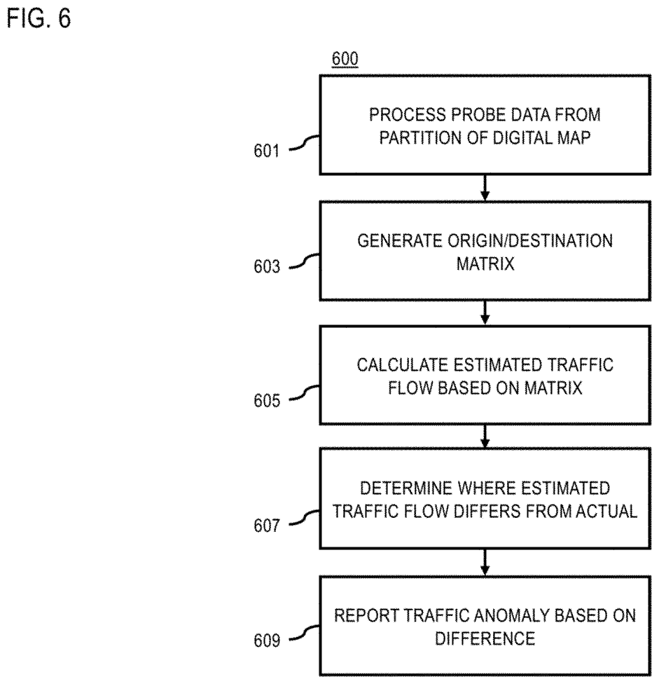

FIG. 5 is a diagram of the components of a traffic platform 111, according to one embodiment. By way of example, the traffic platform 111 includes one or more components for detecting traffic anomalies in real-time using sparse probe-data according to the various embodiments described herein. It is contemplated that the functions of these components may be combined or performed by other components of equivalent functionality. In this embodiment, the traffic platform 111 includes a probe data module 501, a graphing module 503, a calculation module 505, a traffic flow module 507, and a communication module 509. The above presented modules and components of the traffic platform 111 can be implemented in hardware, firmware, software, or a combination thereof. Though depicted as a separate entity in FIG. 1, it is contemplated that the traffic platform 111 may be implemented as a module of any of the components of the system 100 (e.g., a component of one or more vehicles 113a-113k (also collectively referred to herein as vehicles 113), services platform 103, services 105, etc.). In another embodiment, one or more of the modules 501-509 may be implemented as a cloud-based service, local service, native application, or combination thereof. The functions of the traffic platform 111 and modules 501-509 are discussed with respect to FIGS. 6-8 below.

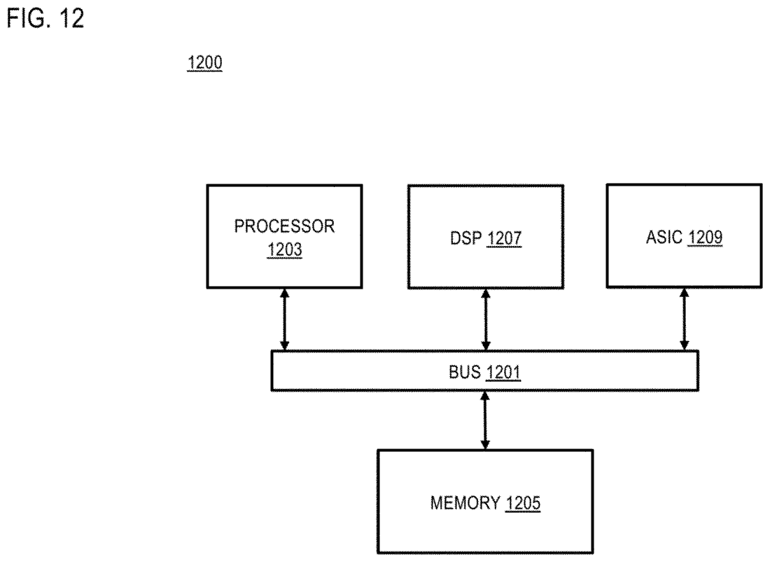

FIG. 6 is a flowchart of a process for detecting traffic anomalies or incidents in real-time using sparse probe-data according to one embodiment. In various embodiments, the traffic platform 111 and/or any of the modules 501-509 may perform one or more portions of the process 600 and may be implemented in, for instance, a chip set including a processor and a memory as shown in FIG. 12. As such, the traffic platform 111 and/or any of the modules 501-509 can provide means for accomplishing various parts of the process 600, as well as means for accomplishing embodiments of other processes described herein in conjunction with other components of the system 100. Although the process 600 is illustrated and described as a sequence of steps, it is contemplated that various embodiments of the process 600 may be performed in any order or combination and need not include all of the illustrated steps.

In step 601, the probe data module 501 processes probe data collected from a partition (e.g., partition 201) of a digital map (e.g., map 200) to determine at least one probe origin point, at least one probe destination point, or a combination thereof. In one instance, the probe data is collected at a boundary of the partition, at an internal source or sink within the partition, or at a combination thereof. By way of example, a vehicle 113 may start or park inside of the area and generate a source or sink for the O/D matrix in a road inside of the partition. In one instance, the probe data may be crowd-sourced data coming from one or more user equipment (UE) 119a-119n (also collectively referred to herein as UEs 119) associated with a user or a vehicle 113 (e.g., an insurance tracker, a mobile device, or in-vehicle navigation systems). As described above, in densely populated areas, there is often more than enough probe and/or third-party information related to each road network; however, in less densely populated and/or rural areas, the absence of probe or crowd-sourced information is problematic. In one embodiment, a partition (e.g., area 201) is created from a larger road link graph of the digital map (e.g., map 200). For example, the digital map 200 may comprise a road network of a city or town (e.g., city 203 “Wrightsville”), a state, a country, or even a group or region including proximate or adjacent countries. In one embodiment, the partition 201 is formed by partitioning the map 200 at one or more natural cuts of the larger road link graph. In this instance, the one or more natural cuts (e.g., the river 205, the park 207, the sparse areas 209, and the freeway 211) are each identified by the PUNCH algorithm. Although the partition 201 depicted and described with respect to FIG. 2 appears exclusive, the probe data module 501 can process probe data collected from an exclusive partition, one or more overlapping partitions, or a combination thereof.

In one instance, the probe data module 501 may process probe data stratified according to a contextual attribute, and wherein the traffic anomaly is detected with respect to the contextual attribute. For example, the contextual attribute may include one or more temporal parameters (e.g., day of the week), one or more vehicle types (e.g., automobile, truck, bus, etc.), one or more average modes of travel (e.g., vehicle, bicycle, walking, etc.), or a combination thereof.

In step 603, the graphing module 503 generates an O/D matrix (e.g., O/D matrix 330) for the partition based on the at least one probe origin point, at least one probe destination point, or the combination thereof. In one embodiment, the probe data module 501 considers the at least one probe origin point as the origin (O) and the at least one probe destination point as the destination (D). As described above, for each partition (e.g., partition 201), the graphing module 503 generates an O/D matrix (e.g., O/D matrix 330) based on the probe origin points (e.g., O1, O2, O3, O4, and O5) and the probe destination points (e.g., D1, D2, D3, D4, and D5). In one embodiment, the graphing module 503 then maps the calculated travel paths (e.g., roads 301, 303, 305, 307, and 309) onto the roadway graph or closure link graph, as shown in FIGS. 3A and 4.

In step 605, the calculation module 505 calculates an estimated traffic flow for a plurality of road segments of the partition based on the O/D matrix (e.g., O/D matrix 330). In one embodiment, the calculation module 505 calculates the estimated traffic flow by processing the O/D matrix (e.g., O/D matrix 330) and map data (e.g., map 200) associated with the plurality of road segments (e.g., roads 301, 303, 305, 307, and 309) using the TA algorithm. In this instance, the calculation module 505 respectively assigns the trips O1-D2, O2-D1, O3-D3, O4-D4, and O5-D5 to the roads 301, 303, 305, 307, and 309 to estimate the traffic volumes and travel times on the routes as a function of the network, wherein the underlying assumption is that users will change their route if a shorter route is available (e.g., road 305 versus road 301). In one embodiment, the calculation module 505 predicts an optimum traffic distribution over the plurality of road segments (e.g., roads 301, 303, 305, 307, and 309) of the partition (e.g., area 201) using the TA algorithm to find the Nash or user equilibrium based on the traffic or map capacity data, free flow data (i.e., free flow speeds), or a combination thereof (e.g., stored in the geographic database 109) for the plurality of road segments queried from the digital map (e.g., map 200).

In step 607, the traffic flow module 507 determines at least one road segment (e.g., road 305) from among the plurality of road segments (e.g., roads 301, 303, 305, 307, and 309) for which the estimated traffic flow differs by more than a difference threshold value from an observed traffic flow indicated by the probe data for the least one road segment. In one embodiment, the observed traffic flow is determined from probe data collected at a partition or boundary of a digital map (e.g., area 201 of map 200) entering or exiting the partition or boundary (e.g., partition 201). In one instance, the observed traffic flow also includes probe data collected at existing internal sources and sinks (e.g., D4 and O5, respectively). In one embodiment, the difference threshold value is greater than a value representing one or more typical traffic flow anomalies (e.g., >3 or 4). In one example, the calculation module 505 can calculate based on map capacity and free flow speed (i.e., the speed at which a vehicle travels the route unencumbered) that an example estimated traffic flow of road 301 (O1-D2) is 14; 2 on road 303 (O2-D1); 15 on road 305 (O3-D3), 2 on road 307 (O4-D4), and 3 on road 309 (O5-D5). Intuitively, this makes sense because roads 305 and 301 appear to be the main west-east and north-south roads, respectively, within the partition 201 and road 305 appears much wider than road 301. Further, as shown in FIGS. 3A and 3B, the probe data module 501 can determine that the example observed traffic flow between O1 and D2 is 4 and that the observed traffic flow between O3 and D3 is close to null and/or 0. In both instances, the traffic flow module 507 can determine that the respective differences (e.g., 10 and 15) are greater than a threshold value (e.g., 10 and 15>3 or 4). In one embodiment, the traffic flow module 507 can also more generally determine the existence of any differences or anomalies between the estimated traffic flow and the observed traffic flow for a road or route using a function of the estimated traffic flow and the map data, statistical analysis, machine learning, or a combination thereof.

By way of comparison, the calculation module 505 can determine that the example estimated traffic flow between O2 and D1 (road 303) is 2 and the probe data module 501 can determine that the example observed traffic flow is 3. As such, the difference (e.g., 1) is less than the threshold value (e.g., 1>3 or 4). The fact that the probe data module 501 determines a slight increase in observed traffic flow (e.g., 3) compared to the estimated traffic flow (e.g., 2→3) may reasonably be explained by the differences between the estimated and observed traffic flows of roads 301 and 305 (i.e., one or more users may have modified their original travel plan, routes, navigation, etc. according to the Nash equilibrium).

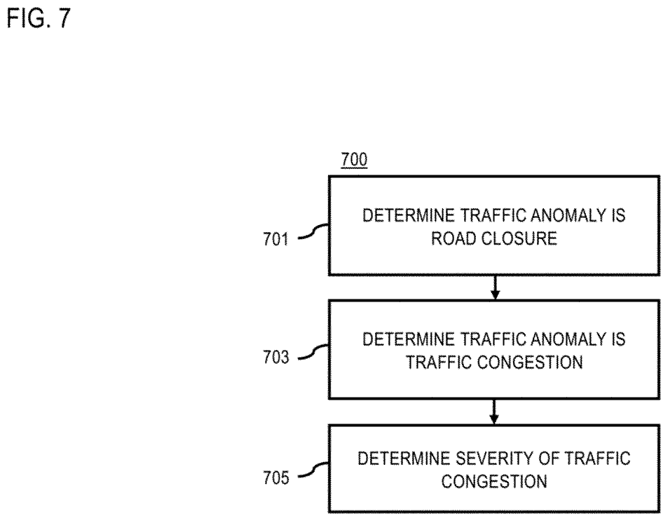

FIG. 7 is a flowchart of a process of describing a traffic anomaly or incident on a road segment based on a comparison of theoretical and actual traffic flows on the segment, according to one embodiment. In various embodiments, the traffic platform 111 and/or any of the modules 501-509 may perform one or more portions of the process 700 and may be implemented in, for instance, a chip set including a processor and a memory as shown in FIG. 12. As such, the traffic platform 111 and/or any of the modules 501-509 can provide means for accomplishing various parts of the process 700, as well as means for accomplishing embodiments of other processes described herein in conjunction with other components of the system 100. Although the process 700 is illustrated and described as a sequence of steps, it is contemplated that various embodiments of the process 700 may be performed in any order or combination and need not include all of the illustrated steps.

In step 701, once the traffic flow module 507 determines that an estimated traffic flow differs by more than a difference threshold value (e.g., >3 or 4) from an observed traffic flow in step 607, the traffic flow module 507 determines that the traffic anomaly is a road closure based on determining that the estimated traffic flow is greater than a traffic flow minimum and that the observed traffic flow is less than a null threshold value. By way of example, the traffic flow minimum can mean that there is at least some expectation or estimation of a minimum level of traffic on the route (e.g., ≥1). In this example, the traffic flow module 507 can determine that the traffic anomaly on road 305 is a closure based on the calculation module 505 determining that the estimated or theoretical flow (e.g., 10 or 15) is greater than the traffic flow minimum (e.g., 15≥1) and the probe data module 501 determining that the observed traffic flow (e.g., 0) is less than the null threshold value (e.g., 0<1).

By way of comparison, the traffic flow module 507 can determine that the traffic anomaly on road 301 is at least not a road closure and that there is no traffic anomaly or incident on road 303. Specifically, the calculation module 505, in this instance, can determine that the estimated flow for the road 301 (e.g., 14) and the road 303 (e.g., 2) are greater than the traffic flow minimum (e.g., 14 and 2≥1), however, the probe data module 501 can also determine that the observed traffic flows for road 301 (e.g., 4) and road 303 (e.g., 3) are both greater than the null threshold value (e.g., 4 and 3>1). Therefore, the traffic flow module 507 can determine that neither road comprises a road closure. However, the traffic flow module 507 can determine that the difference (e.g., 10) between the estimated traffic flow of route 303 (e.g., 14) and the observed traffic flow (e.g., 4) is greater than the difference threshold value (e.g., 10>3 or 4) whereas the traffic flow module 507 can also determine that the difference (e.g., 1) between the estimated traffic flow of road 303 (e.g., 2) and the observed traffic flow (e.g., 3) is less than the difference threshold value (e.g., 1<3 or 4). Consequently, the traffic flow module 507 can determine that road 301 comprises a traffic anomaly that is at least not a road closure and that road 303 does not comprise a traffic anomaly.

In step 703, the traffic flow module 707 determines that the traffic anomaly is a traffic congestion incident (i.e., heavy congestion) based on determining that the estimated traffic flow is greater than a traffic flow minimum and that the observed traffic is greater than a null threshold value and less than the estimated traffic flow by the different threshold value. By way of example, the traffic flow module 707 can determine that the traffic anomaly or incident on road 301 comprises traffic congestion based on the calculation module 505 determining that the estimated traffic flow (e.g., 14) is greater than the traffic flow minimum (e.g., 14≥1) and the probe data module 501 determining that the observed traffic (e.g., 4) is greater than the null threshold value (e.g., 4>1) and less than the estimated traffic flow (e.g., 14) by at least the difference threshold value (e.g., 10>3 or 4). By way of comparison, as described with respect to step 701, the probe data module 501 can determine that the traffic anomaly on road 305 comprises a road closure and that there is no traffic anomaly on road 303. In one embodiment, the traffic flow module 707 can also determine that the traffic anomaly is a traffic congestion based on determining that the estimated traffic flow differs according to a function of the estimated traffic flow and map data, statistical analysis, machine learning, or a combination thereof from the observed traffic flow indicated by the probe data for the road.

In step 705, the traffic flow module 507 determines a severity level of the traffic congestion based on a magnitude of a difference between the estimated traffic flow and the observed traffic flow. In one embodiment, the closer the difference between the estimated traffic flow and the observed traffic flow is to the difference threshold value (e.g., 3 or 4), the traffic flow module 507 determines that the traffic congestion is less severe. Conversely, the further the difference between estimated traffic flow and the observed traffic flow, the traffic flow module 507 determines that the traffic congestion is more severe. By way of example, the difference between the estimated traffic flow and the observed traffic flow of road 303 (e.g., 10) may be indicative of heavy congestion.

Returning to FIG. 6, in step 609, the communication module 509 provides data to indicate a detection of the traffic anomaly on the at least one road segment based on the difference between the estimated traffic flow and the observed traffic flow (i.e., the data is provided by the communication module 509 if a traffic anomaly exists on the road segment). By way of example, the communication module 509 may provide data (e.g., a road closure report 101) to user via a navigation application of a UE 119 (e.g., a mobile device or in-vehicle navigation display). In one embodiment, the traffic anomaly is a detected anomaly of the digital map data for the partition (e.g., partition 201) based on the traffic flow module 507 designating the observed traffic flow as a ground truth value.

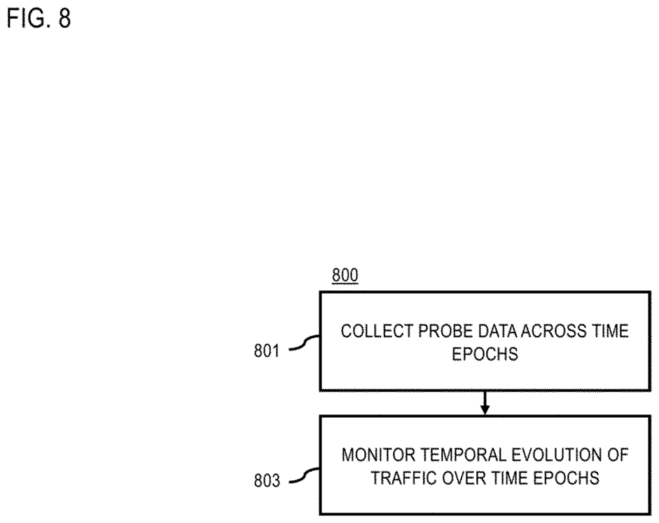

FIG. 8 is flowchart of a process for monitoring a temporal evolution of traffic on a road segment, according to one embodiment. In various embodiments, the traffic platform 111 and/or any of the modules 501-509 may perform one or more portions of the process 800 and may be implemented in, for instance, a chip set including a processor and a memory as shown in FIG. 12. As such, the traffic platform 111 and/or any of the modules 501-509 can provide means for accomplishing various parts of the process 800, as well as means for accomplishing embodiments of other processes described herein in conjunction with other components of the system 100. Although the process 800 is illustrated and described as a sequence of steps, it is contemplated that various embodiments of the process 800 may be performed in any order or combination and need not include all of the illustrated steps.

In step 801, the probe data module 501 collects the probe data across a plurality of time epochs. By way of example, a time epoch may represent any temporal period relevant to traffic flow (e.g., a few minutes, a few hours, a few days, etc.). In one example, the time epoch comprises 10-15 minutes. In one embodiment, the probe data module 501 collects and processes the probe data in the same or similar way that the probe data module 501 processes probe data in step 601; however, in this instance, the probe data module 501 processes the probe data over a plurality of time epochs (e.g., every 10-15 minutes).

In step 803, the traffic flow module 507 monitors a temporal evolution of the traffic by calculating the estimated traffic flow and the observed traffic flow to detect the traffic anomaly over the plurality of time epochs. By way of example, in time epoch t, the traffic flow module 507 can determine that the estimated traffic flow on road 305 (e.g., 15) differs from the observed traffic flow (e.g., 0) by more than a difference threshold value (e.g., 15>3 or 4). The traffic flow module 507 can then determine that the traffic anomaly is a road closure based on a determination that the estimated traffic flow (e.g., 15) is greater than a traffic flow minimum (e.g., 15≥1) and that the observed traffic flow (e.g., 0) is less than a null threshold value (e.g., 0<1). In time epoch t+1 (e.g., 1 hour later), the traffic flow module 507 can determine that there is still a traffic anomaly on road 303 based on the difference between the estimated traffic flow (e.g., 15) and the observed traffic flow (e.g., 5) being more than the difference threshold value (e.g., 10>3 or 4); however, in time epoch t+1, the observed traffic flow (e.g., 5) is no longer less than the null threshold value (e.g., 5>1). Rather, during time epoch t+1, the traffic flow module 507 can determine that the traffic anomaly on road 305 comprises heavy congestion based on determining that the estimated traffic flow (e.g., 15) is greater than the traffic flow minimum (e.g., 15≥1) and that the observed traffic flow (e.g., 5) is greater than the null threshold value and less than the estimated traffic flow (e.g., 15) by at least the difference threshold value (e.g., 10>3 or 4). In the instance of a progressive evolution of traffic, the traffic flow module 507 may determine that in epoch t+2 (e.g., 2 hours later) that there is no longer a traffic anomaly on road 305. For example, the traffic flow module 507 may determine that the observed traffic flow (e.g., 13) no longer differs from the estimated traffic flow (e.g., 15) by more than the difference threshold value (e.g., 2<3 or 4). In one instance, the temporal evolution of the traffic on a road or route may be progressive, regressive, or random over the plurality of time epochs.

Returning to FIG. 1, in one embodiment, the traffic platform 111 has connectivity over a communication network 117 to other components of the system 100 including but not limited to road closure reports 101, services platform 103, services 105, content providers 107, geographic database 109, and/or vehicles 113 (e.g., probes). By way of example, the services 105 may also be other third-party services (e.g., crowd-sourced services) and include traffic anomaly or incident services (e.g., to report road closures), mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 103 uses the output (e.g. road closure and heavy traffic conditions reports) of the traffic platform 111 to provide services such as navigation, mapping, other location-based services, etc.

In one embodiment, the vehicles 113 also have connectivity to the UEs 119 having connectivity to the traffic platform 111 via the communication network 117. In one embodiment, the traffic platform 111 may be a cloud-based platform that creates the partition (e.g., partition 201) from a larger road link graph of the digital map (e.g., map 200), generates a O/D matrix for the partition (e.g., O/D matrix 330), calculates an estimated traffic flow for a plurality of read segments (e.g., using a TA algorithm), or a combination thereof. In one embodiment, the sensors 115a-115k (also collectively referred to herein as sensors 115) (e.g., camera sensors, light sensors, Light Detection and Ranging (LiDAR) sensors, Radar, infrared sensors, thermal sensors, and the like) acquire navigation-based data during an operation of the vehicle 113 along the one or more travel paths (e.g., roads 301, 303, 305, 307, and 309) between boundary points of the partition or area (e.g., partition 201).

In one embodiment, the UEs 119 can be associated with any of the vehicles 113 or a user or a passenger of a vehicle 113. By way of example, a UE 119 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that a UE 119 can support any type of interface to the user (such as “wearable” circuitry, etc.). In one embodiment, the vehicles 113 may have cellular or wireless fidelity (Wi-Fi) connection either through the inbuilt communication equipment or the UEs 119 associated with the vehicles 113. Also, the UEs 119 may be configured to access the communication network 117 by way of any known or still developing communication protocols.

In one embodiment, the traffic platform 111 may be a platform with multiple interconnected components (i.e., distributed). In one instance, the traffic platform 111 may include multiple servers, intelligent networking devices, computing devices, components and corresponding software for providing parametric representations of lane lines. In addition, it is noted that the traffic platform 111 may be a separate entity of the system 100, a part of the one or more services 105, a part of the services platform 103, or included within a vehicle 113.

In one embodiment, the content providers 107 may provide content or data (e.g., including geographic data, parametric representations of mapped features, etc.) to the services platform 103, the services 105, the geographic database 109, the traffic platform 111, and the vehicles 113. The content provided may be any type of content, such as traffic anomaly or incident content (e.g., road closure reports), map content, textual content, audio content, video content, image content, etc. In one embodiment, the content providers 107 may provide content that may aid in the detecting and classifying of road closures or other traffic anomalies or incidents. In one embodiment, the content providers 107 may also store content associated with the services platform 103, services 105, geographic database 109, traffic platform 111, and/or vehicles 113. In another embodiment, the content providers 107 may manage access to a central repository of data, and offer a consistent, standard interface to data, such as a repository of the geographic database 109.

In one embodiment, the vehicles 113, for instance, are part of a probe-based system for collecting probe data for detecting traffic anomalies and/or measuring traffic conditions in a road network. In one embodiment, each vehicle 113 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 113 may include sensors 115 for reporting measuring and/or reporting attributes. The attributes can also be any attribute normally collected by an on-board diagnostic (OBD) system of the vehicle, and available through an interface to the OBD system (e.g., OBD II interface or other similar interface). In one embodiment, this data allows the system 100 to determine a probe entry point, a probe exist point, or a combination thereof occurring at a boundary of the partition (e.g., partition 201).

The probe points can be reported from the vehicles 113 in real-time, in batches, across a plurality of time epochs, continuously, or at any other frequency requested by the system 100 over, for instance, the communication network 117 for processing by the traffic platform 111. The probe points also can be mapped to specific road links stored in the geographic database 109.

In one embodiment, a vehicle 113 is configured with various sensors 115 for generating or collecting vehicular sensor data, related geographic/map data, etc. In one embodiment, the sensed data represent sensor data associated with a geographic location or coordinates at which the sensor data was collected. In this way, the sensor data can act as observation data that can be separated into location-aware training and evaluation datasets according to their data collection locations as well as used for detecting traffic anomalies in real-time using sparse probe-data to the embodiments described herein. By way of example, the sensors may include a radar system, a LiDAR system, a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on steering wheels of the vehicles, switch sensors for determining whether one or more vehicle switches are engaged, and the like.

Other examples of sensors of a vehicle 113 may include orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of a vehicle 113 may detect the relative distance of the vehicle from a physical divider, a lane or roadway, the presence of other vehicles (e.g., distances between vehicles during free flow travel and distances during periods of high congestion), pedestrians, traffic lights, potholes and any other objects, or a combination thereof. In one scenario, the sensors may detect weather data, traffic information, or a combination thereof. In one embodiment, a vehicle 113 may include GPS or other satellite-based receivers to obtain geographic coordinates from satellites for determining current location and time. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In one embodiment, the communication network 117 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the services platform 103, services 105, content providers 107, traffic platform 111, and/or vehicles 113 communicate with each other and other components of the system 100 using well known, new or still developing protocols. In this context, a protocol includes a set of rules defining how the network nodes within the communication network 117 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

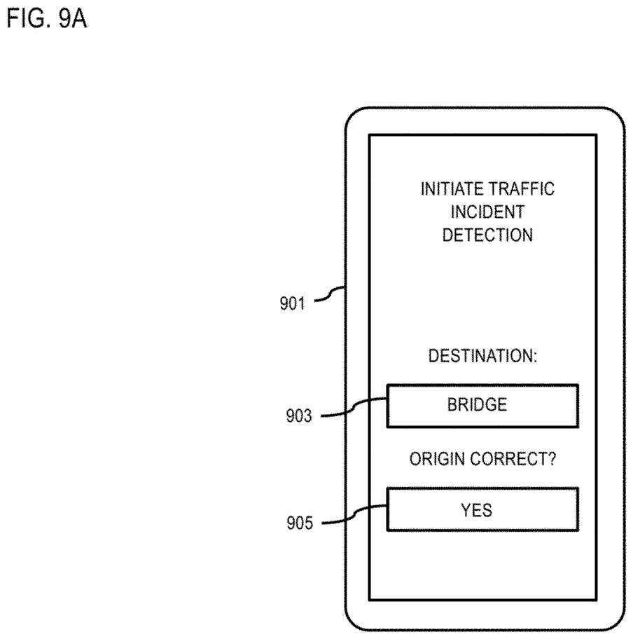

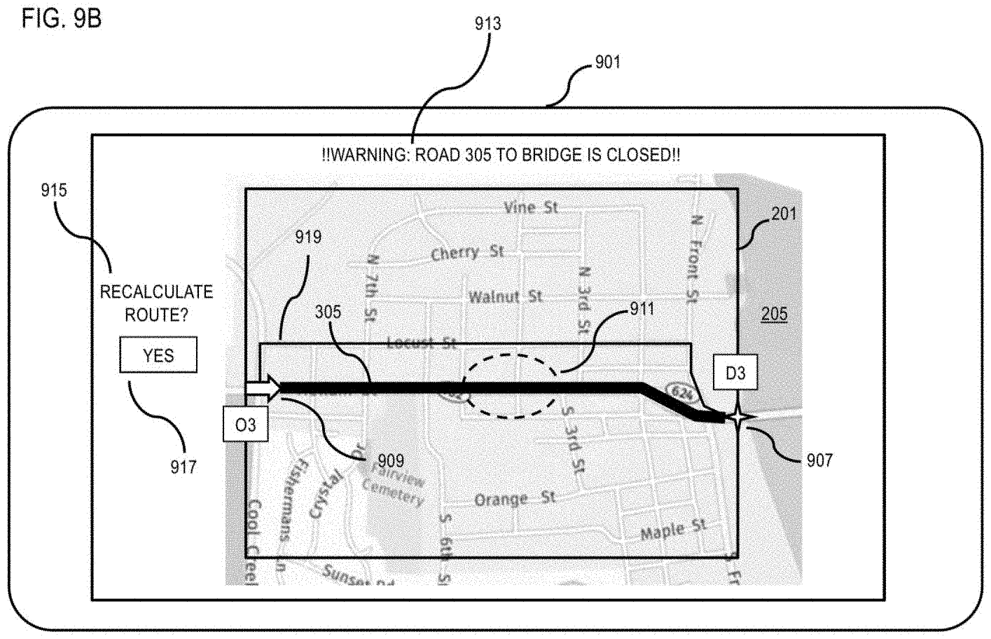

FIGS. 9A and 9B are diagrams of example user interfaces for detecting traffic anomalies in real-time using sparse probe-data, according to one embodiment. In this example, a UI 901 is generated for a UE 115 (e.g., a vehicle navigation device, a mobile device, or a combination thereof) that includes an input 903 that enables a user to enter a destination (i.e., a probe destination point) and an input 905 to confirm that the system 100 correctly determined the user's current position (i.e., a probe origin point), for example, based on the location of the UI 901. In this instance, following the example of FIGS. 2-4, the user can enter the bridge 907 (D3) at the end of the road 305 that goes over the natural cut (e.g., the river 205) as her or his destination and can confirm that starting point 909 (O3) is her or his current position. In this instance, the user intends to travel on the road 305 at a very early hour and as a result there is an absence of probe or crowd-sourced information related to the road segment.

In one embodiment, based on the user's designation of the probe origin point (O3) and the probe destination point (D3), the system 100 can access the O/D matrix 330 for the partition 201 based on the probe origin and probe destination points (e.g., stored in the geographic database 109). Based on the O/D matrix 330, the system 100 can access the calculated estimated traffic flow for the road 305, which in this example is a value of 8 (not 15) given the time of day. The system 100 can also access the observed traffic flow (e.g., stored in the geographic database 109), which in this example is still 0. In one embodiment, the system 100 can then determine that there is a traffic anomaly or incident on road 305 based on the estimated traffic flow (e.g., 8) and the observed traffic flow (e.g., 0) differing by more than the difference threshold value (e.g., 8>3 or 4). Further, the system 100 can determine and/or confirm that road 305 is closed based on the determination that the estimated traffic flow (e.g., 8) is greater than the traffic flow minimum (e.g., 8≥1) and that the observed traffic flow (e.g., 0) is less than the null threshold value (e.g., 0<1).

In one embodiment, the system 100 provides data to the user to indicate that a traffic anomaly has been detected. For example, the system 100 can provide the data through a route or road graphic 911 (e.g., indicating that road 305 is closed), a notification 913 (e.g., “!!Warning: Road 305 to Bridge is CLOSED!!”), or a combination thereof. In one embodiment, the system 100 could also provide the data to a user via one or more audio-based alerts, one or more shakes or vibrations, or a combination thereof. By way of example, the system 100 could cause the UE 901 to vibrate for a road closure and beep for heavy congestion or vice-versa. In one embodiment, the system 100 can provide the user with a prompt 915 (e.g., “Recalculate Route?”) based on the assumption that according to the Nash equilibrium users will change paths if a shorter route is available. To this end, the UI 901 can include an input 917 (e.g., “Yes” or “No”) to cause the system 100 to detect a traffic condition with respect to another route within the partition 201 (e.g., road 919). Consequently, unlike current systems that would be blind in detecting road closures in real-time within the partition 201, the system 100 can infer the ability or inability to traverse a road segment (e.g., road 305) based on information on the boarders and/or within an area 201 containing the road segment 205 and map data.

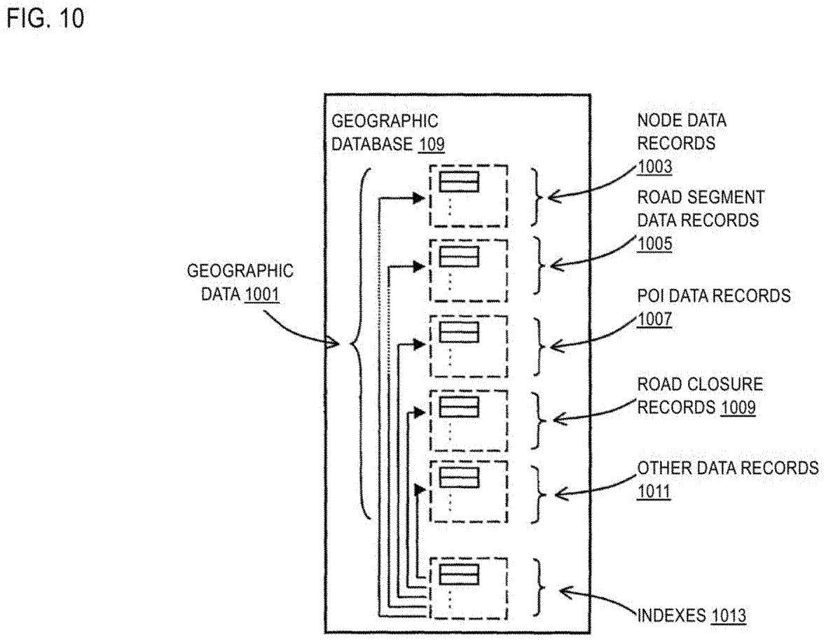

FIG. 10 is a diagram of a geographic database, according to one embodiment. In one embodiment, the geographic database 109 includes geographic data 1001 used for (or configured to be compiled to be used for) mapping and/or navigation-related services. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 109.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non-reference node”).

“Simple polygon”—An interior area of an outer boundary formed by a string of oriented links that begins and ends in one node. In one embodiment, a simple polygon does not cross itself

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 109 follows certain conventions. For example, links do not cross themselves and do not cross each other except at a node. Also, there are no duplicated shape points, nodes, or links. Two links that connect each other have a common node. In the geographic database 109, overlapping geographic features are represented by overlapping polygons. When polygons overlap, the boundary of one polygon crosses the boundary of the other polygon. In the geographic database 109, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 109 includes node data records 1003, road segment or link data records 1005, POI data records 1007, road closure data records 1009, other records 1011, and indexes 1013, for example. More, fewer or different data records can be provided. In one embodiment, additional data records (not shown) can include cartographic (“carto”) data records, routing data, and maneuver data. In one embodiment, the indexes 1013 may improve the speed of data retrieval operations in the geographic database 109. In one embodiment, the indexes 1013 may be used to quickly locate data without having to search every row in the geographic database 109 every time it is accessed. For example, in one embodiment, the indexes 1013 can be a spatial index of the polygon points associated with stored feature polygons.

In exemplary embodiments, the road segment data records 1005 are links or segments representing roads, streets, or paths, as can be used in the calculated route or recorded route information for determination of one or more personalized routes. The node data records 1003 are end points corresponding to the respective links or segments of the road segment data records 1005. The road link data records 1005 and the node data records 1003 represent a road network, such as used by vehicles, cars, and/or other entities. Alternatively, the geographic database 109 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 109 can include data about the POIs and their respective locations in the POI data records 1007. The geographic database 109 can also include data about places, such as cities, towns, or other communities, and other geographic features, such as bodies of water, mountain ranges, etc. Such place or feature data can be part of the POI data records 1007 or can be associated with POIs or POI data records 1007 (such as a data point used for displaying or representing a position of a city).

In one embodiment, the geographic database 109 includes the road closure data records 1009 for storing predicted road closure reports, road closure evaluations, road closure link graphs, associated probe data/vehicle paths, and/or any other related data. The road closure data records 1009 comprise of the road closure data layer 123 that store the automatically generated road closure classifications generated according to the various embodiments described herein. The road closure data layer 123 can be provided to other system components or end users to provided related mapping, navigation, and/or other location-based services. In one embodiment, the road closure data records 1009 can be associated with segments of a road link (as opposed to an entire link). In other words, the segments can further subdivide the links of the geographic database 109 into smaller segments (e.g., of uniform lengths such as 5-meters). In this way, road closures or other traffic anomalies can be predicted and represented at a level of granularity that is independent of the granularity or at which the actual road or road network is represented in the geographic database 109. In one embodiment, the road closure data records 1009 can be associated with one or more of the node records 1003, road segment or link records 1005, and/or POI data records 1007; or portions thereof (e.g., smaller or different segments than indicated in the road segment records 1005) to provide situational awareness to drivers and provide for safer autonomous operation of vehicles.

In one embodiment, the geographic database 109 can be maintained by the content provider 107 in association with the services platform 103 (e.g., a map developer). The map developer can collect geographic data to generate and enhance the geographic database 109. There can be different ways used by the map developer to collect data. These ways can include obtaining data from other sources, such as municipalities or respective geographic authorities. In addition, the map developer can employ field personnel to travel by vehicle along roads throughout the geographic region to observe features (e.g., road closures or other traffic anomalies or incidents, etc.) and/or record information about them, for example. Also, remote sensing, such as aerial or satellite photography, can be used.

In one embodiment, the geographic database 109 include high resolution or high definition (HD) mapping data that provide centimeter-level or better accuracy of map features. For example, the geographic database 109 can be based on LiDAR or equivalent technology to collect billions of 3D points and model road surfaces and other map features down to the number lanes and their widths. In one embodiment, the HD mapping data capture and store details such as the slope and curvature of the road, lane markings, roadside objects such as sign posts, including what the signage denotes. By way of example, the HD mapping data enable highly automated vehicles to precisely localize themselves on the road, and to determine road attributes (e.g., learned speed limit values) to at high accuracy levels.

In one embodiment, the geographic database 109 is stored as a hierarchical or multi-level tile-based projection or structure. More specifically, in one embodiment, the geographic database 109 may be defined according to a normalized Mercator projection. Other projections may be used. By way of example, the map tile grid of a Mercator or similar projection is a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom or resolution level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grid 10. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid 10. In one embodiment, the quadkey is an example of the hash or encoding scheme of the respective geographical coordinates of a geographical data point that can be used to identify a tile in which the geographical data point is located.

The geographic database 109 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the vehicle 113, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for detecting traffic anomalies in real-time using sparse probe-data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

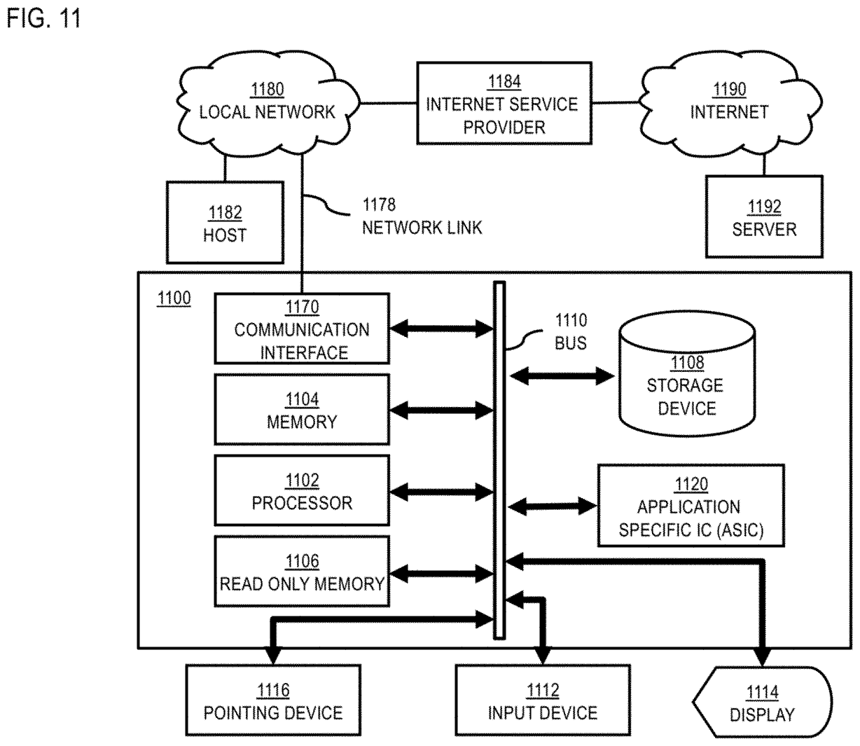

FIG. 11 illustrates a computer system 1100 upon which an embodiment of the invention may be implemented. Computer system 1100 is programmed (e.g., via computer program code or instructions) to detect traffic anomalies in real-time using sparse probe-data as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to detect traffic anomalies in real-time using sparse probe-data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random-access memory (RAM) or other dynamic storage device, stores information including processor instructions for detecting traffic anomalies in real-time using sparse probe-data. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for detecting traffic anomalies in real-time using sparse probe-data, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general, the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 117 for detecting traffic anomalies in real-time using sparse probe-data.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 12 illustrates a chip set 1200 upon which an embodiment of the invention may be implemented. Chip set 1200 is programmed to automatically evaluate road closure reports as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to automatically evaluate road closure reports. The memory 1205 also stores the data associated with or generated by the execution of the inventive steps.

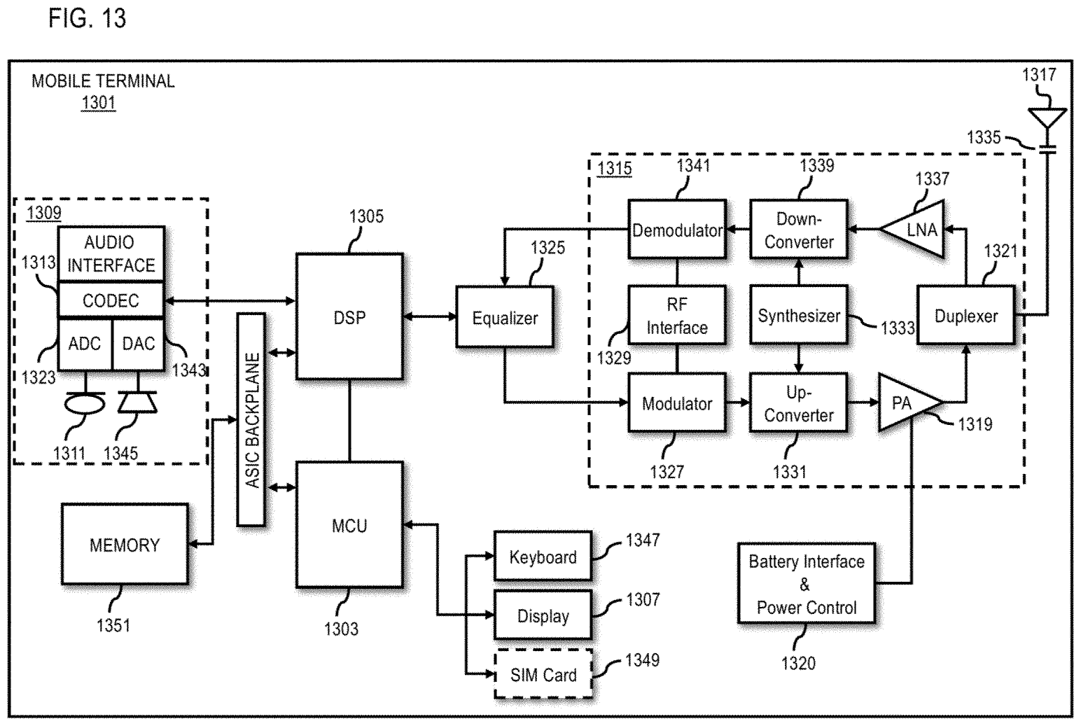

FIG. 13 is a diagram of exemplary components of a mobile terminal 1301 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile station 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to automatically evaluate road closure reports. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile station 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile station 1301 on a radio network. The card 1349 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method for detecting a traffic anomaly comprising:
processing probe data collected from a partition of a digital map to determine at least one probe origin point, at least one probe destination point, or a combination thereof;
generating an origin/destination matrix for the partition based on the at least one probe origin point, at least one probe destination point, or the combination thereof;
calculating an estimated traffic flow for a plurality of road segments of the partition based on the origin/destination matrix;
determining at least one road segment from among the plurality of road segments for which the estimated traffic flow differs by more than a difference threshold value from an observed traffic flow indicated by the probe data for the least one road segment; and
providing data to indicate a detection of the traffic anomaly on the at least one road segment based on the difference.

2. The method of claim 1, wherein the estimated traffic flow is calculated by processing the origin/destination matrix and map data associated with the plurality of road segments using a traffic assignment algorithm.

3. The method of claim 2, wherein the traffic assignment algorithm predicts an optimum traffic distribution over the plurality of road segments of the partition based on a traffic capacity data, free flow speed data, or a combination thereof for the plurality of road segments queried from the digital map.

4. The method of claim 1, further comprising:
determining that the traffic anomaly is a road closure based on determining that the estimated traffic flow is greater than a traffic flow minimum and that the observed traffic flow is less than a null threshold value.

5. The method of claim 1, further comprising:
determining that the traffic anomaly is a traffic congestion incident based on determining that the estimated traffic flow is greater than a traffic flow minimum and that the observed traffic flow is greater than a null threshold value and less than the estimated traffic flow by at least the difference threshold value.

6. The method of claim 5, further comprising:
determining a severity level of the traffic congestion based on a magnitude of a difference between the estimated traffic flow and the observed traffic flow.

7. The method of claim 1, wherein the traffic anomaly is a detected anomaly of the digital map data for the partition based on designating the observed traffic flow as a ground truth value.

8. The method of claim 1, further comprising:
collecting the probe data across a plurality of time epochs; and
monitoring a temporal evolution of the traffic by calculating the estimated traffic flow and
the observed traffic flow to detect the traffic anomaly over the plurality of time epochs.

9. The method of claim 1, wherein the probe data is stratified according to a contextual attribute, and wherein the traffic anomaly is detected with respect to the contextual attribute.

10. The method of claim 1, wherein the partition is created from a larger road link graph of the digital map by partitioning at one or more natural cuts of the larger road link graph.

11. An apparatus for detecting a traffic anomaly comprising:
at least one processor; and
at least one memory including computer program code for one or more programs,
the at least one memory and the computer program code configured to, with the at least one processor, cause the apparatus to perform at least the following,
generate an origin/destination matrix for a partition of a digital map based on at least one probe origin point, at least one probe destination point, or a combination thereof determined from probe data collected from the partition;
calculate an estimated traffic flow for a plurality of road segments of the partition based on the origin/destination matrix and map data associated with the plurality of road segments; and
compare the estimated traffic flow to an observed traffic flow indicated by the probe data to detect a traffic anomaly on at least one road segment.

12. The apparatus of claim 11, wherein the estimated traffic flow is calculated by processing the origin/destination matrix and the map data using a traffic assignment algorithm.

13. The apparatus of claim 11, wherein the apparatus is further caused to:
determine that the traffic anomaly is a road closure based on determining that the estimated traffic flow is greater than a traffic flow minimum and that the observed traffic flow is less than a null threshold value.

14. The apparatus of claim 11, wherein the at least one road segment is determined from among the plurality of road segments, and wherein the estimated traffic flow for the at least one road segment differs according to a function of the estimated traffic flow and map data, a statistic analysis, a machine learning, or a combination thereof from the observed traffic flow for the at least one road segment.

15. The apparatus of claim 14, wherein the apparatus is further caused to:
determine that the traffic anomaly is a traffic congestion incident based on determining that the estimated traffic flow is greater than a traffic flow minimum and that the observed traffic is greater than a null threshold value and less than the estimated traffic flow by at least the function of the estimated traffic flow and map data, the statistical analysis, the machine learning, or the combination thereof.

16. A non-transitory computer-readable storage medium for detecting a traffic anomaly, carrying one or more sequences of one or more instructions which, when executed by one or more processors, cause an apparatus to perform:
generating an origin/destination matrix for a partition of a digital map based on the at least one probe origin point, at least one probe destination point, or a combination thereof determined from probe data collected from the partition;
calculating an estimated traffic flow for a plurality of road segments of the partition based on the origin/destination matrix and map data associated with the plurality of road segments;
comparing the estimated traffic flow to an observed traffic flow indicated by the probe data to detect a traffic anomaly on at least one road segment; and
providing data to update a geographic database based on the traffic anomaly.

17. The non-transitory computer-readable storage medium of claim 16, wherein the estimated traffic flow is calculated by processing the origin/destination matrix and the map data using a traffic assignment algorithm.

18. The non-transitory computer-readable storage medium of claim 16, wherein the apparatus is further caused to perform:
determining that the traffic anomaly is a road closure based on determining that the estimated traffic flow is greater than a traffic flow minimum and that the observed traffic flow is less than a null threshold value.

19. The non-transitory computer-readable storage medium of claim 16, wherein the at least one road segment is determined from among the plurality of road segments, and wherein the estimated traffic flow for the at least one road segment differs by more than a difference threshold value from the observed traffic flow for the at least one road segment.

20. The non-transitory computer-readable storage medium of claim 19, wherein the apparatus is further caused to perform:
determining that the traffic anomaly is a traffic congestion incident based on determining that the estimated traffic flow is greater than a traffic flow minimum and that the observed traffic is greater than a null threshold value and less than the estimated traffic flow by the difference threshold value.
